(19) United States
(12) Patent Application Publication
(10) Pub. No.: US 2017/0206804 A1
(43) Pub. Date: Jul. 20, 2017

(54) INTERACTIVE ADD-ON DEVICE FOR KIDS FOR A TOOTHBRUSH AND A PLATFORM FOR MOBILE DEVICES CONTAINING GAMES CONTROLLED BY THAT DEVICE

(71) Applicant: FUNBRUSH LTD., LONDON (GB)

(72) Inventors: ADAM ROSZYK, POZNAN (PL); MlLOSZ CISOWSKI, KOMORNIKI (PL); ANDRZEJ CHOMONT, NOWOGROD BOBRZANSKI (PL)

(73) Assignee: FUNBRUSH LTD., LONDON (GB)

(21) Appl. No.: 15/269,548

(22) Filed: Sep. 19, 2016

Related U.S. Application Data
(60) Provisional application No. 62/219,980, filed on Sep. 17, 2015.

(51) Int. Cl. G09B 19/00; A46B 15/00; A63F 13/79; A63F 13/85; A63F 13/211

(52) U.S. Cl. CPC G09B 19/0084; A63F 13/85; A63F 13/211; A63F 13/79; A46B 15/0006

(57) ABSTRACT

The invention related to an interactive add-on device (FunBrush) for kids for a toothbrush and a platform for mobile devices containing games controlled by the device to create a habit of correct, regular tooth brushing by virtual fun. The device is attachable to a manual or electric toothbrush and comprises PCB board, battery, a button responsible for turning device on and off and controlling elements of the platform, microprocessor, wireless system (Bluetooth 4.0 LE), accelerometer, gyro, and magnetometer. The device is connected to an existing mobile device located on a toothbrush. A material for a cover is variable with TPE-V as a prototype material.

### BACKGROUND OF THE INVENTION

1. Field of the Invention

The invention relates to an educational game.

2. Brief Description of the Background of the Invention Including Prior Art

### SUMMARY OF THE INVENTION

1. Purposes of the Invention

It is a purpose of the invention to provide a game for children.

2. Brief Description of the Invention

The user starts the application on a mobile device (hereinafter referred to as the device).

Then the user starts the funbrush machine by briefly holding down the button on the device (hereinafter referred to as funbrush)

The inclusion of funbrush is indicated by the illumination of the LEDs.

Funbrush sends secured authorization data to a device that allows its diagnosis.

After authorization funbrush becomes the cursor in the game menu.

Rotation of funbrush “apart¹ moves the cursor down, ‘to himself up, ‘left¹ to the left “right¹ to the right.

Funbrush wirelessly transmits data continuously to the device.

The data are interpreted by the device using proprietary software algorithms.

The Player chooses the transmission link to the next menu screen by a corresponding rotation of funbrush and pressing funbrush when the cursor is on a link, or by waiting a short while when the cursor is on a link.

Data on the quantities of held games and scored points record in the device memory and/or on a remote server.

During the main game funbrush sends the sensor data to the device.

The device interprets the data using proprietary software algorithms and converts the movements of funbrush to the movements of animated brush or other cursor while playing on the device

Differences between FunBrush and U.S.20070270221.
Funbrush is not (but may be) embedded in oral care tool. Funbrush can be attached onto any kind of toothbrush.
Funbrush does not contain base unit—it is connected to existing mobile device.
Game is controlled by device, not by hand.
   Funbrush represents movement and position of toothbrush in real time—not only used to control game.
some parts of platform are password-restricted, only a parent can access them.

FunBrush • interactive add-on (controller) for kids for a toothbrush and a platform for mobile devices (tablets and smart phones) containing games controlled by this addon. The purpose of this set is to create a habit of correct, regular tooth brushing by virtual fun.

FunBrush contains:

1. Add-on (control (hardware) device)—universal controller to put on a manual or electric toothbrush, containing electronic device that sends data about position and rotation of a controller wirelessly.

Device Contains:
PCB board
battery
   button responsible for turning device on and off and controlling elements of the platform
microprocessor
wireless system (Bluetooth 4.0 LE)
accelerometer
gyro
magnetometer

Material for cover is variable. Prototyping material will be TPE-V.

### DESCRIPTION OF FEATURES OF THE INVENTION

1. Intro Trivia

Every time a loading screen shows up, the player sees a short text-trivia, which can be seen for about 10 seconds.
Trivias are loaded from predefined database
Trivias appear in random order
Trivias are shown in parametric way, loading a Lion there are Lion trivias.

2a. Profiles

Profiles is a feature known from many games and apps. Every Player while logging in creates a unique profile. Changes and achievements for one profile are not shown for other profiles.

2. Starting game for the first time we create a profile writing name, age and choosing sex.

3. Every time a game is started we choose one of previously created profiles.
Profile can be added/changed/deleted in settings
Profiles have their avatars to choose or a possibility to choose a photo.

4. Character Selection Screen is a horizontal animated background with possibility of choosing particular characters. The Player is scrolling through characters with swype and can choose any with a tap. On the left there is an extra panel with Menu Elements and Game Activities.

Screen is animated. In the main menu most of the elements visible on the screen are animated, starting with characters and background, buttons, texts and there are swype animations.

Characters move differently, depending on what the Player is doing. If nothing happens for a while there is a different animation.

5,6,7,8. Available Characters.

Every character (Lion, Hippo, Dino, Princess) is unique, adjusted for a particular target and can be used for every Game Activities.

9. Menu Elements—Extra Features Besides Game Activities: Profile, Customization, Goals, Album, Settings.

10. Game Activities are different activities that a player can play with using FunBrush: Brushing, Exercises, Cleaning, Playing, Eating, Hairdressing, Showering.

11. Go to 2a., 2., 3.

12. Customization

Customization of your Characters.

While swyping through every Character in Character Selection in Side Panel there is an icon with sunglasses with starts Customization.

In this feature there are many different items that can be attached on the Character by the Player. Every item can be rotated, scaled and deleted.
While the Player exits this mode, all changes are saved automatically.
Changes can be seen in Character Selection and in Customization
The Player can customize any available Character
Changes are shown in Brushing mode

13. Goals

Customizable goals created by the parent of the Player

It is a feature, thanks to which children can choose together with a parent the goal they want to achieve (e.g. going for the ice cream to the shopping center). We choose also the conditions for the goal.

SMART goal:

[Who] [What] [Where] [Why] if for [x] day I will brush min [y] times a day.

Checkboxes:

Is that goal achievable?

Do I want to achieve that?.

Example: Together with my mom I will go to get ice cream because I love them if I will brush for 5 days min 2 times a day.
In main menu there is a special field to enter the Goal
We show changing examples (3)
Depending on x and y Goal is achieved as 100%=x*y
In Character Selection there is a Goal meter.

14. Album with photos. Album is a place where you can save photos of your characters, that you dressed in Customization, thanks to that the Player can easily personalize his profile choosing a photo from an Album for an avatar or look through his creations.

15. Setting is a feature having all the elements for sound control, legal and credits.

16-22. 7 Game Activities

Every Game Activity is an interactive mini-game controlled with FunBrush. Every day we can play only 3 times. Every time we play a game there is a growing health bar.

Game Activities:

16. Brushing

Brushing is the most advanced activity. Information about movement of the FunBrush is translated and this movement is represented on the screen.
Each character has its teeth brushed in 16 positions: jaw is divided into 6 parts (3 upper and 3 bottom). Parts upper left, upper right, bottom left and bottom right is brushed from 3 sides: external, internal and chewing surfaces. Parts upper middle and bottom middle are only brushed externally and internally.
Teeth are dirt that jumps out of them as we brush.
Brushing takes 2 minutes.
There is a sound of brushing.
In the middle of brushing there is time for spitting out the foam.
Device rotation is translated into the game.
There is a ghost toothbrush that shows brushing technique (FIG. 29).
Start and end of this mode have animations of opening and closing the jaw.
At the end of brushing there are shiny stars on teeth

17. Playing

Playing is about moving feather in 4 different places (behind ears, on the neck, depending on a character. Next to the feather there is an animation of the movement. This mode is based on movement and animations (FIG. 30).
On the screen there is a Character visible and Playing animation
There is a sound of laughing and moving the feather
There is a mini jaw that shows which teeth we should be brushing.
FunBrush movement influences feather movement
During movement in every place the Character is animated and moves out of the feather

18. Exercising

Physical exercises is a mode based on animations—the faster you brush the faster the Character moves or moves its limbs. There is no ‘brushing element’ in this mode (FIG. 31)'
Characters are redrawn in position to exercise
Exercise sounds
Mini-jaw shows which teeth we are brushing
Brushing movements influence limb movements
Animations

19. Showering

Character is under the shower and we move a big brush over snap-points and clean the Character. There is foam and Character changes from dirty to clean
Screen shows the Character and there is foam animations which stays on the Character
Sound of showering
Mini-jawshows which teeth we are cleaning
FunBrush movements influence where the foam is created

20. Feeding

On the screen there is visible head of the Character and in every corner of the screen there is different food. By brushing teeth with FunBrush, the Player cuts the food and throws that to Characters mouth.

For 10 Seconds the Player is cutting and for 5 seconds he throws the food into the mouth; We show 8 types of food in 4 corners. While eating leftovers jumps out of Characters mouth.
Eating and cutting sounds
Mini jaw shows which teeth we are cleaning
FunBrush movements influence cutting animation

21. Cleaning

On the screen there is a Characters paddock, which is dirty. The player has to clean it using a brush and a dustpan. By using FunBrush, the Player is throwing dirt into dustpan. At the end all the dirt lands in a bin. There is a dust animation.
There are different types of dirt: papers, cans, bones
Dirt jumps to dustpan and to bin
Sweeping sounds
Mini-jaw show which teeth we are cleaning
FunBrush movements influence brush movement

22. Hairdressing

Player uses FunBrush to control comb. Dirt in hair has snap points and the

Player has to comb it out.
The dirt is jumping out of hair
Stars make Dino shining
Mini-jaw shows which teeth we are cleaning

Extra Features

a) Progress mechanism (FIG. 32).

Motivational mechanism which makes the Player wants to come back to game to get his statistics better. Every health bar represents one of Game Activities. Every Character has its own statistics that are independent.

Health Bar Names:
brushing—teeth
playing—fun
exercise—activity
showering—hygiene
feeding—food
cleaning—cleanness
hairdressing—hair

How it works:
Every-bar can use 120 point, but 100 point is a full bar
Every day automatically there is −20 points everywhere
Passing any Activity gives us 60 points

Each Character has independent statistics

Statistics are active for chosen Character

Statistics are shown visually

Progressing on statistics is notified with sound and animation

b) Unlocking Characters (FIG. 33).

Mechanism works as shown, Characters are unlocked every 2 weeks.
Each Character has a counter showing' how many days left for unlocking
Character is shaded with a lock

c) Mini-jaw

During brushing there is a small jaw symbolizing in which region the Player should brush his teeth.
Teeth is divided into 4 quarters
Every quarter is highlighted for 30 seconds
Brushing time depend on FunBrush movements, if the device is moving, the timer is counting.

### BRIEF DESCRIPTION OF THE SEVERAL VIEWS OF THE DRAWINGS

FIG. 1 shows the separated Add-On Device for Kids for a Toothbrush in relation to the toothbrush

FIG. 2 shows the Add-On Device installed on the toothbrush

FIG. 3 shows a perspective bottom view of the Add-On Device

FIG. 4 shows a left side view of the Add-On Device

FIG. 5 shows a perspective top view of the Add-On Device

FIG. 6 shows a bottom view of the Add-On Device

FIG. 7 shows a front view of the Add-On Device

FIG. 8 shows a top view of the Add-On Device

FIG. 9 shows a perspective bottom view of the Add-On Device

FIG. 10 shows a left side view of the Add-On Device

FIG. 11 shows a perspective top view of the Add-On Device

FIG. 12 shows an electrical diagram for the Add-On Device operation

FIG. 13 shows an electrical diagram for the Add-On Device operation

FIG. 14 shows an electrical diagram for the Add-On Device operation

FIG. 15 shows an electrical diagram for the Add-On Device operation

FIG. 16 shows an electrical diagram for the Add-On Device operation

FIG. 17 shows an electrical diagram for the Add-On Device operation

FIG. 18 shows an electrical diagram for the Add-On Device operation

FIG. 19 shows the Add-On Device installed on the toothbrush with part description

FIG. 20 shows icons describing type of software used in connection with the Add-On Device

FIG. 21 shows an explored view of the Add-On Device

FIG. 22 shows an introduction page of one of the games

FIG. 23 shows a calendar

FIG. 24 shows an electrical diagram for the Add-On Device operation

FIG. 25 shows an introduction page of one of the games

FIG. 26 shows an introduction page of one of the games

FIG. 27 shows the reward model for brushing teeth

FIG. 28 shows a panel

FIG. 29 shows an introduction page of CarX Drift Racing Game

FIG. 30 shows an animated figure of a road runner of one of the games

FIG. 31 shows an animated figure of one of the games

FIG. 32 shows a panel of the Sims

FIG. 33 shows a panel of the Batman Arkham Origins

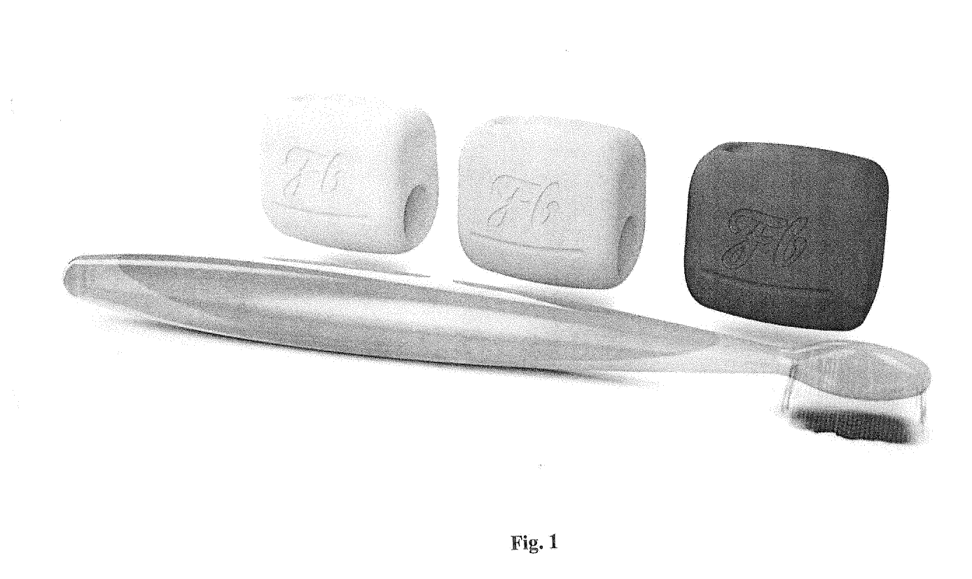

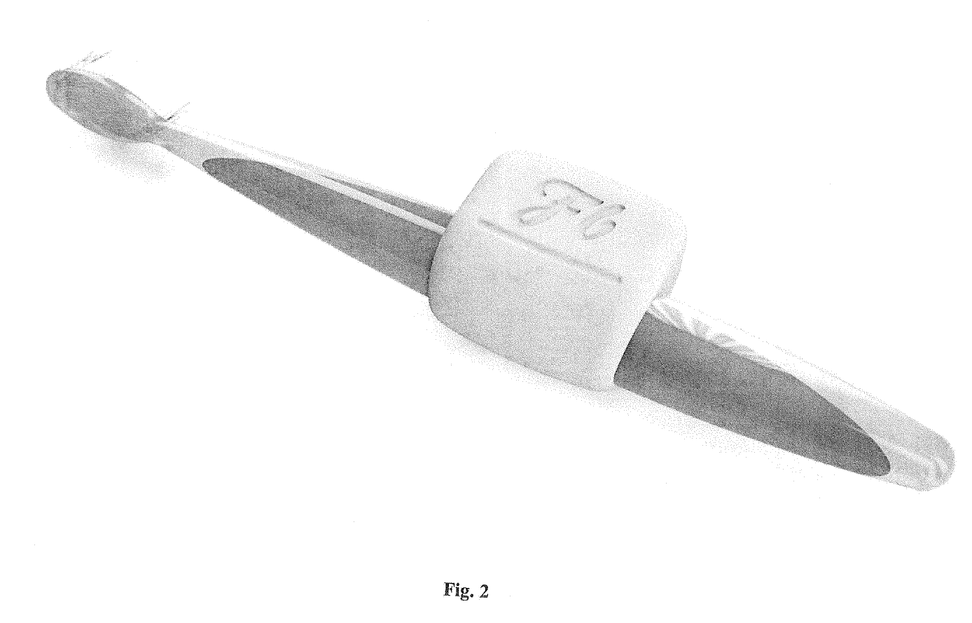

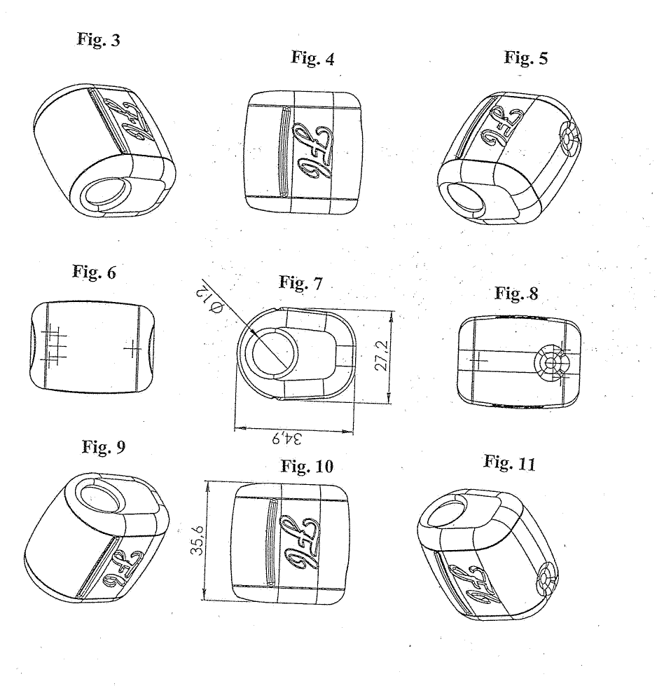

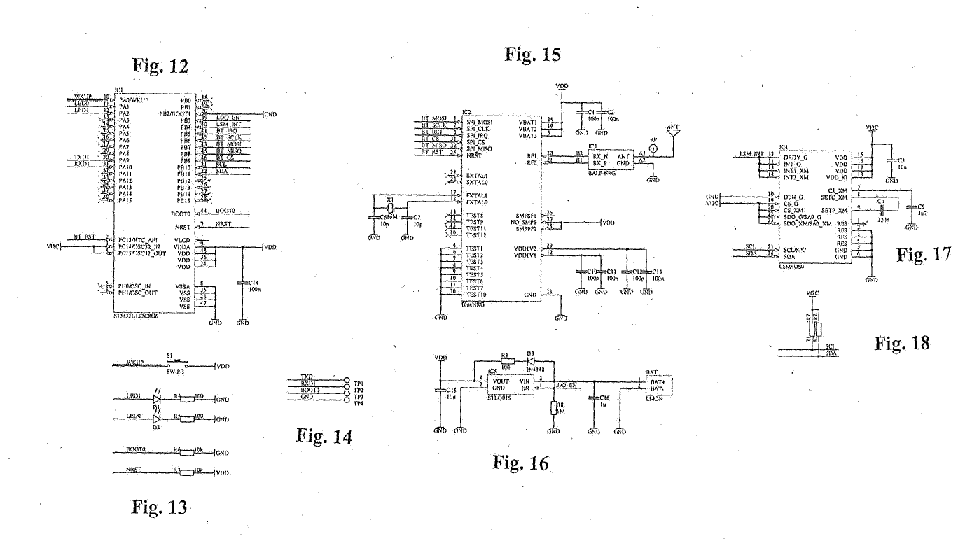

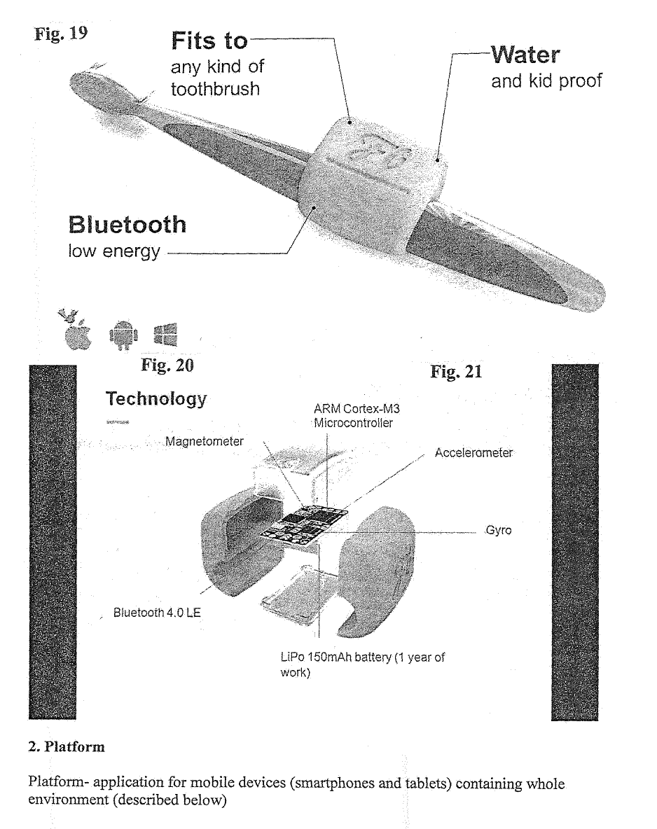

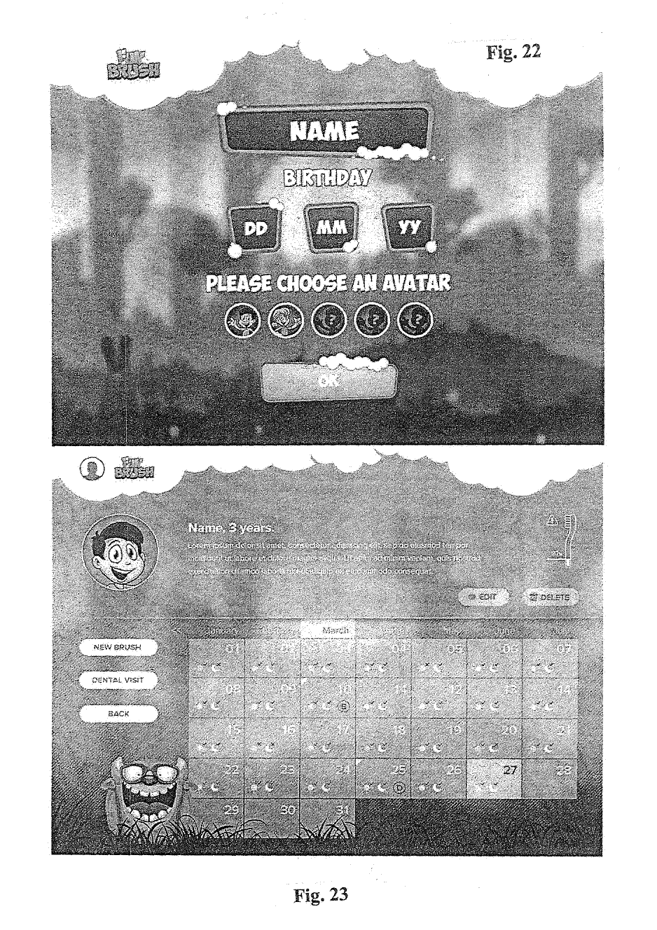

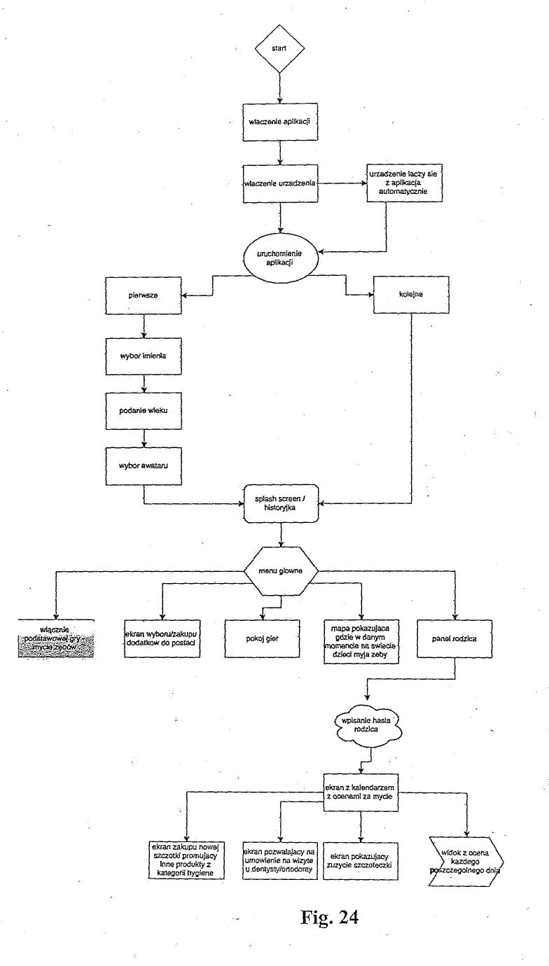

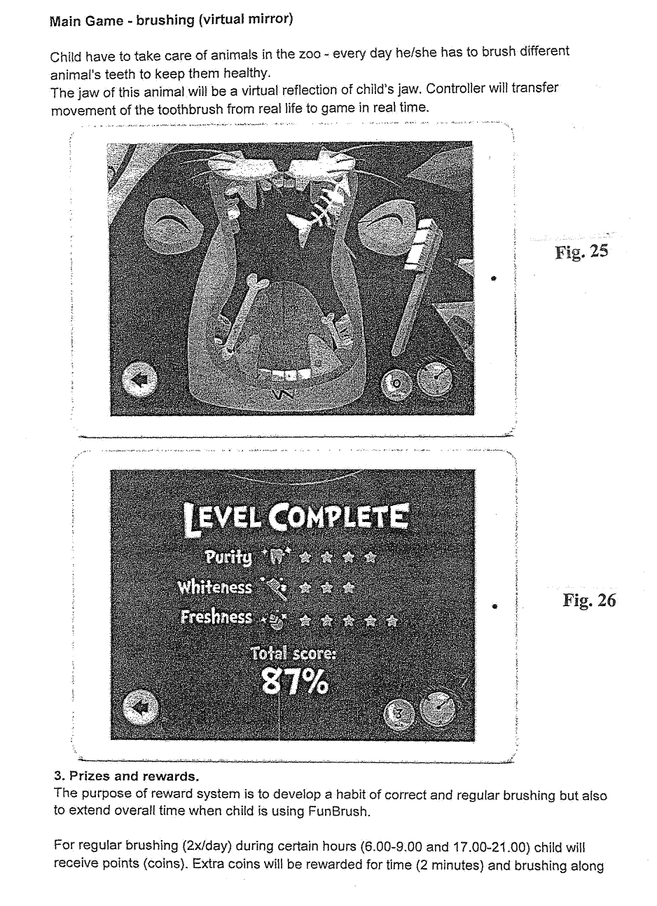

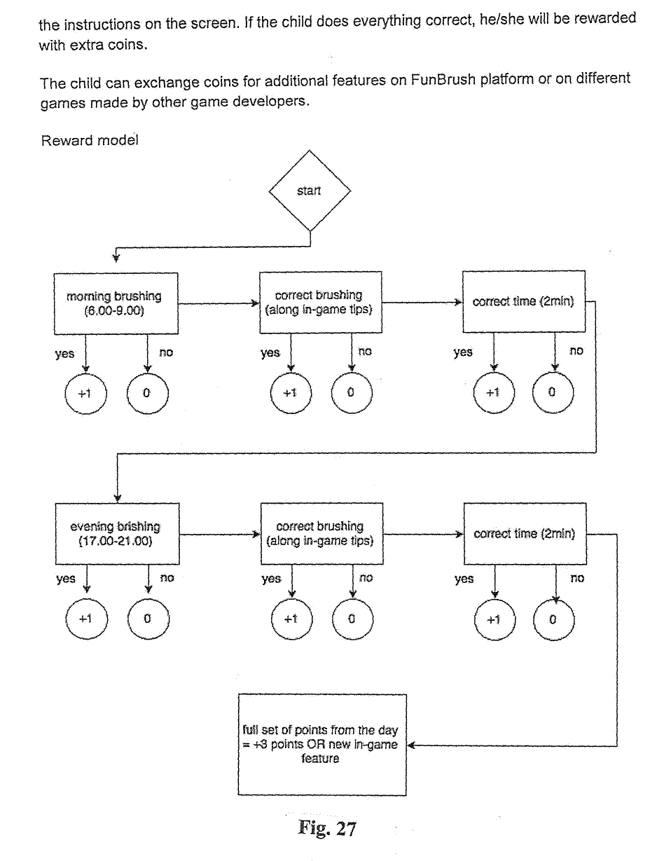

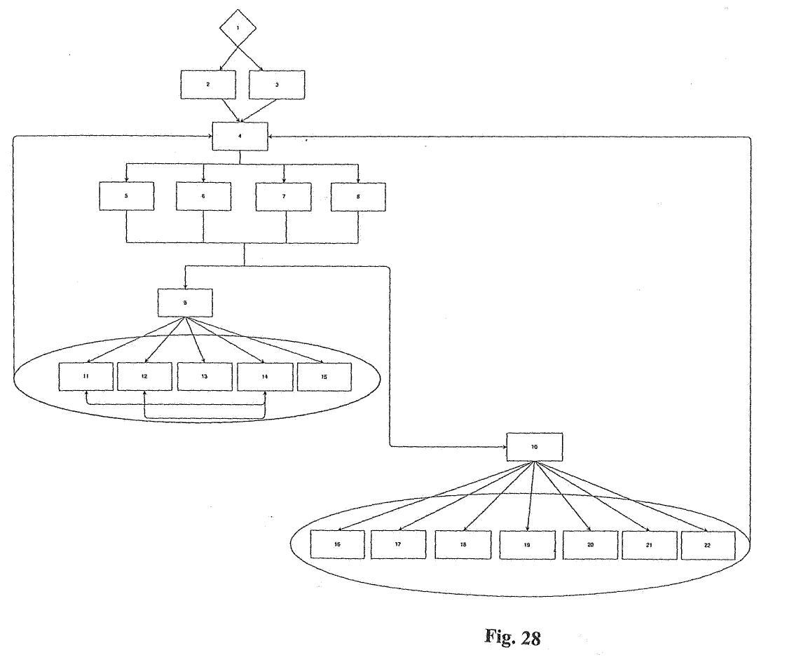

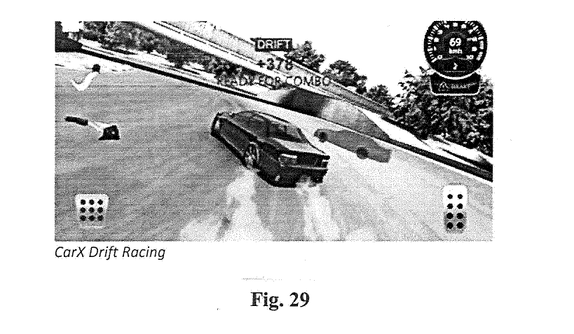

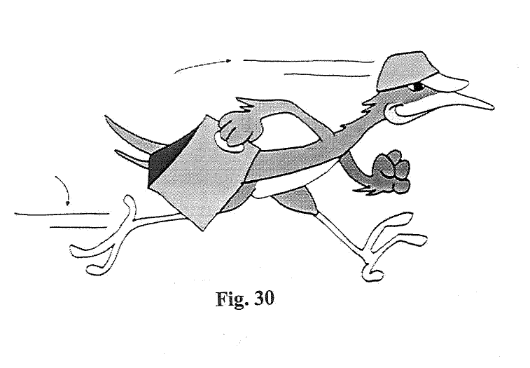

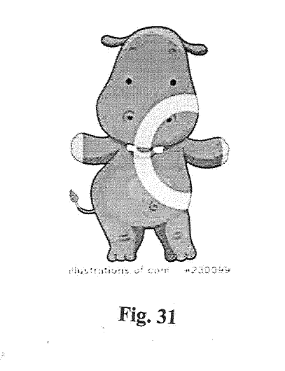

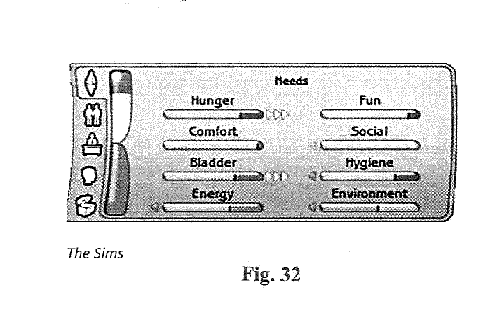

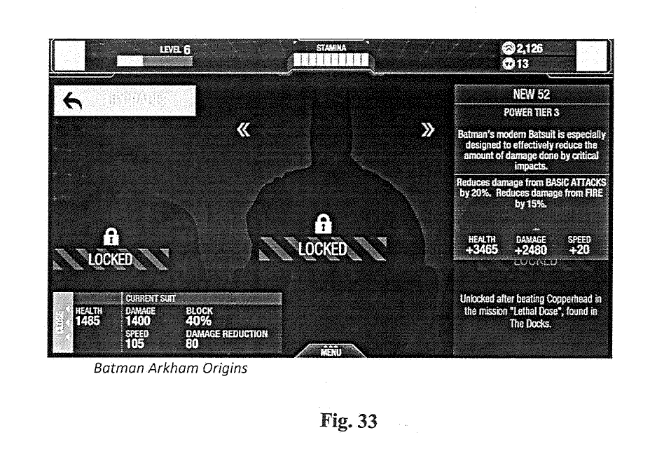

1. An interactive add-on device (FunBrush) for kids for a toothbrush and a platform for mobile devices containing games controlled by the device to create a habit of correct, regular tooth brushing by virtual fun.

2. The interactive device according to claim 1, characterized in that the device is a universal controller device attachable to a manual or electric toothbrush, containing electronic device that sends data about position and rotation of a controller wirelessly.

3. The interactive device according to claim 1, characterize in that the device comprises PCB board, battery, a button responsible for turning device on and off and controlling elements of the platform, microprocessor, wireless system (Bluetooth 4.0 LE), accelerometer, gyro, and magnetometer.

4. The interactive device according to claim 1, wherein a material for a cover is variable with TPE-V as a prototype material.

5. The interactive device according to claim 1, characterized in that the device is connected to an existing mobile device located on a toothbrush.

6. The interactive device according to claim 1, wherein the device is used to control games and to represent movement and position of toothbrush in real time.

7. The interactive device according to claim 1, wherein parts of a platform are password restricted for parents access.

8. The interactive device according to claim 1, characterized in that in the main menu most of the elements visible on the screen are animated.

9. The interactive device according to claim 1, wherein every Player starting a game for the first time creates an unique profile by writing name, age, and choosing sex, wherein changes and achievements for one profile and not shown for other profiles.

10. The interactive device according to claim 1, wherein every character (Lion, Hippo, Dino, Princess) is unique and adjusted for a particular target and can be used for every Game Activities (Brushing, Exercising, Cleaning, Playing, Eating, Hairdressing, Showering).

11. The interactive device according to claim 1, wherein the Player is scrolling through characters with swype and can choose any with a tap.

12. The interactive device according to claim 1, wherein the Player can customize any available character.

13. The interactive device according to claim 1, characterized in that Brushing is the most advanced activity wherein information about a movement of the device, (FunBrush) is translated and the movement is displayed on the screen; wherein each character has its teeth brushed in 16 positions: jaw is divided into 6 parts (3 upper and 3 bottom); wherein parts upper left, upper right, bottom left and bottom right is brushed from 3 sides: external, internal and chewing surfaces, and wherein parts upper middle and bottom middle are only brushed externally and internally.

14. The interactive device according to claim 1, characterized in that extra features besides Game Activities include Profile, Customization, Goals, Album, and Settings.

15. The interactive device according to claim 1, characterized in that the device contains a progress mechanism in Extra Features which motivates the Player to come back to game to get his statistics better.

16. The interactive device according to claim 1, characterized in that goals can be created by the parent of the Player thanks to which children can choose together with a parent the goal they want to achieve (e.g. going for the ice cream to the shopping center).
